(19) United States
(12) Patent Application Publication
(10) Pub. No.: US 2023/0367293 A1
(43) Pub. Date: Nov. 16, 2023

(54) STATE DETERMINATION DEVICE AND STATE DETERMINATION METHOD

(71) Applicant: FANUC CORPORATION, Yamanashi (JP)

(72) Inventor: Atsushi HORIUCHI, Yamanashi (JP)

(21) Appl. No.: 18/246,514

(22) PCT Filed: Oct. 4, 2021
(86) PCT No.: PCT/JP2021/036559

§ 371 Date: Mar. 24, 2023

(30) Foreign Application Priority Data
Oct. 5, 2020 (JP) 2020-168772

(51) Int. Cl. G05B 19/4155; B29C 45/76

(52) U.S. Cl. CPC G05B 19/4155; B29C 45/76; G05B 2219/45244; B29C 2945/76943

(57) ABSTRACT

A state determination device includes a data acquisition unit acquiring the number of productions and data related to a predetermined physical quantity as data indicating a state related to an injection molding machine, a first calculation unit calculating a feature amount indicating a feature of the state based on the data, a second calculation unit calculating a statistic as statistical data with reference to a statistical condition including a statistical function for calculating a predetermined statistic from a predetermined feature amount based on a calculated feature amount, a regression analysis unit performing regression analysis using a predetermined regression formula based on statistical data and the number of productions, and calculating a coefficient of the predetermined regression formula, and a determination unit calculating a divergence degree between a most recent statistic and an obtained regression formula, and determining whether or not the divergence degree is greater than a predetermined threshold value.

### RELATED APPLICATIONS

The present application is a National Phase of International Application No. PCT/JP2021/036559 filed Oct. 4, 2021, which claims priority to Japanese Application No. 2020-168772, filed Oct. 5, 2020.

### TECHNICAL FIELD

The present invention relates to a state determination device and a state determination method related to an injection molding machine.

### BACKGROUND ART

In production of a molded product by an injection molding machine, a determination condition related to molding is set in advance, and quality of the molded product is determined using the determination condition. For example, when a production lot of resin that is a material of the molded product is changed, a plasticization state of resin in an injection cylinder fluctuates, which may cause a defect in the molded product. In addition, a defect may occur in the molded product due to wear of a part such as a screw and running out of grease in a movable portion. Therefore, whether a molding state, which fluctuates due to a change over time or an environmental change, is normal or abnormal is determined based on changes in an injection time or peak pressure in an injection process, and in a feature amount such as a weighing time or a weighing position in a weighing process in a molding cycle.

Even when there is a slight difference in the feature amount compared to the feature amount when the plasticization state of the resin is optimal, as long as the difference is not significant, an abnormality does not necessarily occur in the molded product. Therefore, it is common to provide a permissible range for the determination condition of the feature amount. For example, Patent Document 1 discloses that quality determination is performed based on maximum and minimum values of measurement data detected in each molding cycle. In addition, Patent Documents 2 to 4 disclose that a feature amount (for example, actual value/operation data of an injection time, peak pressure, a weighting position, etc.) is calculated from time-series data, normality (non-defective product) or abnormality (defective product) is determined based on a permissible range of a reference value, a deviation from the reference value, an average value, a standard deviation, etc. related to the calculated feature amount, and information thereof is reported as an alarm (possibility that abnormality occurs in the molded product).

### CITATION LIST

### Patent Document

Patent Document 1: JP H02-106315 A
Patent Document 2: JP H06-231327 A
Patent Document 3: JP 2002-079560 A
Patent Document 4: JP 2003-039519 A

### DISCLOSURE OF THE INVENTION

### Problem to be Solved by the Invention

There are various factors that cause abnormality (defect) in an injection molding machine or a molded product, including accidental factors and medium and long-term factors. Examples of the accidental factors include sensor breakage, intrusion of foreign matter into a movable portion, intrusion of foreign matter into a production material, an operation error of an operator, etc. Meanwhile, examples of the medium and long-term factors include abrasion, wear, and deterioration of a mechanical member (abrasion of a screw, wear of a belt, running out of grease in a movable portion, aged deterioration of an electrical component, abrasion of a mold, etc.), a change in a production environment (deterioration of a production material (resin), change of a resin lot, etc.), etc. The accidental factors and the medium and long-term factors not only differ in the length of time until abnormality occurs, but also in transition of a molding state (production state) until abnormality occurs.

Conventionally, normality or abnormality of a molding state has been determined in real time based on production information or a feature amount obtained during actual molding. Therefore, in the event of a fatal abnormality such as damage to a mechanical part or a mold of the injection molding machine, production of the molded product is inadvertently suspended at the timing when the abnormality is detected. In order to restart production of the molded product in such a situation, there has been a problem that it takes a long time to restore the machine, such as ordering a repair part. In addition, even when it does not lead to a serious problem such as damage to the mechanical part, if there is a delay in noticing that the abnormality has occurred, a large number of defective products will be generated, which leads to a large increase in production costs such as disposal of defective products and material costs. Therefore, it is required to detect a sign of the abnormality at an early stage.

Preventive maintenance can be performed for such a situation by periodically overhauling and inspecting the machine even when no abnormality has occurred. However, an operation of the machine needs to be suspended for overhaul. Therefore, it is desirable to determine whether the molding state is normal or abnormal without stopping the machine in a normal state as much as possible, and to improve an operating rate of the machine.

In addition, abrasion and corrosion of the screw or mold progress slowly over a long period of time to cause an abnormality in a molding state such as occurrence of a defective product or breakage of a mechanical part. Therefore, it is necessary to predict the time when the molding state will become abnormal, and to inspect the injection molding machine and perform maintenance work before the abnormality occurs.

As described above, there is a demand for preventive maintenance technique that enables early detection of an abnormality in a molding state.

### Means for Solving Problem

A state determination device according to the invention calculates a feature amount of time-series data for each molding process (a peak value in the molding process, etc.) based on time-series data related to a molding operation of an injection molding machine (for example, pressure, current, speed, etc.) and the number of productions (number of shots), and calculates a statistic using a statistical function for a plurality of calculated feature amounts. Then, the calculated feature amount is subjected to regression analysis to calculate a regression formula. Normality or abnormality of a molding state is determined based on a statistic (actual measurement value) obtained from time-series data and a permissible range of a predicted value estimated by a regression formula.

Further, an aspect of the invention is a state determination device for determining a molding state in an injection molding machine, the state determination device including a data acquisition unit configured to acquire the number of productions and data related to a predetermined physical quantity as data indicating a state related to the injection molding machine, a feature amount calculation unit configured to calculate a feature amount indicating a feature of a state of the injection molding machine based on the data related to the physical quantity, a feature amount storage unit configured to associate and store the feature amount and the number of productions, a statistical condition storage unit configured to store a statistical condition including at least a statistical function for calculating a predetermined statistic from a predetermined feature amount, a statistical data calculation unit configured to calculate a statistic as statistical data with reference to a statistical condition stored in the statistical condition storage unit based on the feature amount stored in the feature amount storage unit, a statistical data storage unit configured to associate and store the statistical data and the number of productions, a regression analysis unit configured to perform regression analysis using a predetermined regression formula based on statistical data and the number of productions stored in the statistical data storage unit, and calculate a coefficient of the predetermined regression formula, and a determination unit configured to calculate a divergence degree indicating a degree of divergence of a most recent statistic calculated by the statistical data calculation unit from the predetermined regression formula, and determine whether or not the divergence degree is greater than at least one predetermined threshold value.

Another aspect of the invention is a state determination method of determining a molding state in an injection molding machine, the state determination method executing a step of acquiring the number of products and data related to a predetermined physical quantity as data indicating a state related to the injection molding machine, a step of calculating a feature amount indicating a feature of a state of the injection molding machine based on the data related to the physical quantity, a step of calculating a statistic as statistical data according to a statistical condition including at least a statistical function for calculating a predetermined statistic from a predetermined feature amount based on the feature amount, a step of performing regression analysis using a predetermined regression formula based on the statistical data and the number of productions, and calculating a coefficient of the predetermined regression formula, and a step of calculating a divergence degree indicating a degree of divergence of a most recently calculated statistic from the predetermined regression formula, and determining whether or not the divergence degree is greater than at least one predetermined threshold value.

### Effect of the Invention

According to an aspect of the invention, it is possible to find a permissible range for determining that a current molding state is normal based on a statistic indicating a feature of time-series data obtained by actual molding, and to achieve a safe state in such a way that an operator is notified that an abnormality has occurred, or an injection molding machine is suspended when an actual measurement value is out of the permissible range.

### BRIEF DESCRIPTION OF DRAWINGS

FIG. 1 is a schematic hardware configuration diagram of a state determination device according to an embodiment;

FIG. 2 is a schematic configuration diagram of an injection molding machine;

FIG. 3 is a schematic functional block diagram of a state determination device according to a first embodiment;

FIG. 4 is a diagram illustrating an example of a molding cycle for manufacturing one molded product;

FIG. 5 is a diagram illustrating an example of calculating a feature amount from one piece of time-series data;

FIG. 6 is a diagram illustrating an example of calculating a feature amount from two or more pieces of time-series data;

FIG. 7 is a diagram illustrating an example of statistical conditions;

FIG. 8A is a diagram illustrating a graph in which a feature amount for each shot is plotted;

FIG. 8B is a diagram illustrating a graph in which statistical data calculated from a feature amount is plotted;

FIG. 9 is a diagram illustrating a graph of a regression formula;

FIG. 10 is a diagram illustrating an example of a warning display by a determination unit;

FIG. 11 is a diagram illustrating an example of an input screen for statistical conditions;

FIG. 12 is a diagram illustrating an example in which threshold values are provided above and below the regression formula, respectively; and

FIG. 13 is a diagram illustrating an example in which a plurality of threshold values is provided stepwise in an upward direction of the regression formula.

### MODE(S) FOR CARRYING OUT THE INVENTION

Hereinafter, embodiments of the invention will be described with reference to the drawings.

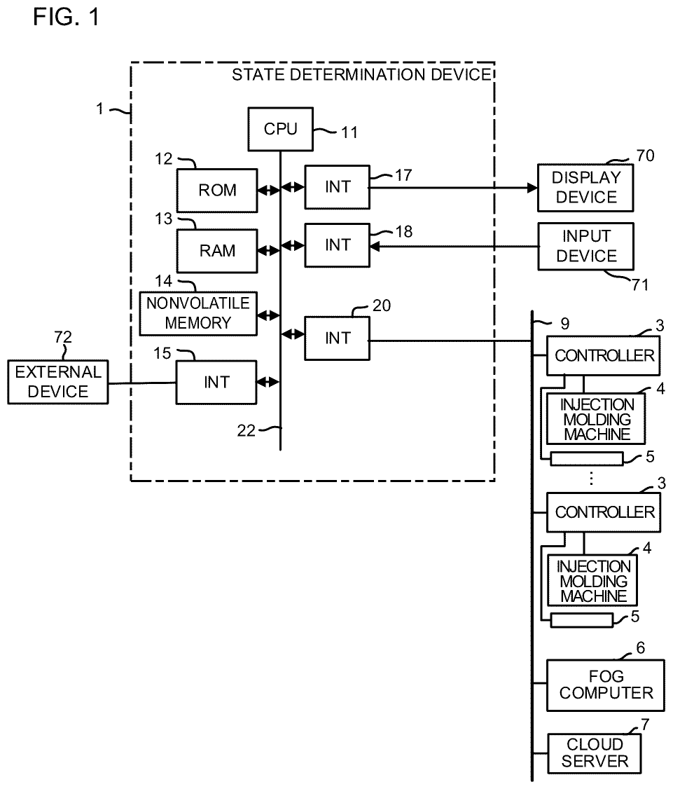

FIG. 1 is a schematic hardware configuration diagram illustrating essential parts of a state determination device according to an embodiment of the invention. For example, the state determination device 1 according to the present embodiment may be mounted as a controller that controls an injection molding machine 4 based on a control program. Further, the state determination device 1 according to the present embodiment may be mounted on a personal computer installed side by side with a controller that controls the injection molding machine 4 based on a control program, a personal computer connected to the controller via a wired/wireless network, a cell computer, a fog computer 6, or a cloud server 7. In the present embodiment, an example in which the state determination device 1 is mounted on a personal computer connected to a controller 3 via a network 9 is illustrated.

A CPU 11 included in the state determination device 1 according to the present embodiment is a processor that controls the state determination device 1 as a whole. The CPU 11 reads a system program stored in a ROM 12 via a bus 22 and controls the entire state determination device 1 according to the system program. A RAM 13 temporarily stores temporary calculation data, display data, various data input from the outside, etc.

For example, a nonvolatile memory 14 includes a memory backed up by a battery (not illustrated), an SSD (Solid State Drive), etc. and retains a storage state even when power of the state determination device 1 is turned off. The nonvolatile memory 14 stores data read from an external device 72 via an interface 15, data input from an input device 71 via an interface 18, data acquired from the injection molding machine 4 via the network 9, etc. For example, the stored data may include data related to physical quantities such as a motor current, voltage, torque, position, speed, and acceleration of a driving unit, pressure in a mold, a temperature of the injection cylinder, a flow rate of resin, a flow velocity of resin, and vibration and sound of the driving unit detected by various sensors 5 attached to the injection molding machine 4 controlled by the controller 3. The data stored in the nonvolatile memory 14 may be loaded in the RAM 13 during execution/use. Further, various system programs such as well-known analysis programs are pre-written to the ROM 12.

The interface 15 is an interface for connecting the CPU 11 of the state determination device 1 and the external device 72 such as an external storage medium. From the external device 72 side, for example, a system program, a program, parameters, etc. related to an operation of the injection molding machine 4 can be read. In addition, data, etc. created/edited on the state determination device 1 side may be stored in the external storage medium such as a CF card or a USB memory (not illustrated) via the external device 72.

An interface 20 is an interface for connecting the CPU of the state determination device 1 and the wired or wireless network 9. For example, the network 9 may perform communication using techniques such as serial communication such as RS-485, Ethernet (registered trademark) communication, optical communication, wireless LAN, Wi-Fi (registered trademark), Bluetooth (registered trademark), etc. The controller 3 for controlling the injection molding machine 4, the fog computer 6, the cloud server 7, etc. are connected to the network 9, and data is exchanged with the state determination device 1.

Each piece of data read on a memory, data obtained as a result of execution of a program, etc. are output and displayed on a display device 70 via an interface 17. In addition, the input device 71 including a keyboard, a pointing device, etc., transfers commands, data, etc. based on an operation by an operator to the CPU 11 via the interface 18.

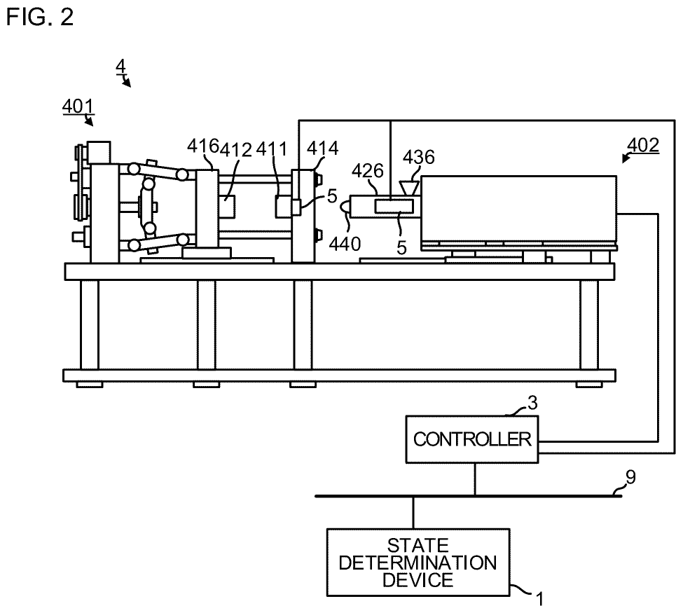

FIG. 2 is a schematic configuration diagram of the injection molding machine 4. The injection molding machine 4 mainly includes a mold clamping unit 401 and an injection unit 402. The mold clamping unit 401 includes a movable platen 416 and a stationary platen 414. In addition, a movable mold 412 is attached to the movable platen 416, and a stationary mold 411 is attached to the stationary platen 414. Meanwhile, the injection unit 402 includes an injection cylinder 426, a hopper 436 for storing a resin material supplied to the injection cylinder 426, and a nozzle 440 provided at a tip of the injection cylinder 426. In a molding cycle for manufacturing one molded product, the mold clamping unit 401 performs mold closing/mold clamping operations by moving the movable platen 416, and the injection unit 402 presses the nozzle 440 against the stationary mold 411 and then injects resin into the mold. These operations are controlled by commands from the controller 3.

In addition, the sensors 5 are attached to respective portions of the injection molding machine 4, and physical quantities such as a motor current, voltage, torque, position, speed, and acceleration of the driving unit, pressure in the mold, a temperature of the injection cylinder 426, a flow rate of resin, a flow velocity of resin, and vibration and sound of the driving unit are detected and sent to the controller 3. In the controller 3, each of the detected physical quantities is stored in the RAM, the nonvolatile memory, etc. (not illustrated), and is transmitted to the state determination device 1 via the network 9 as necessary.

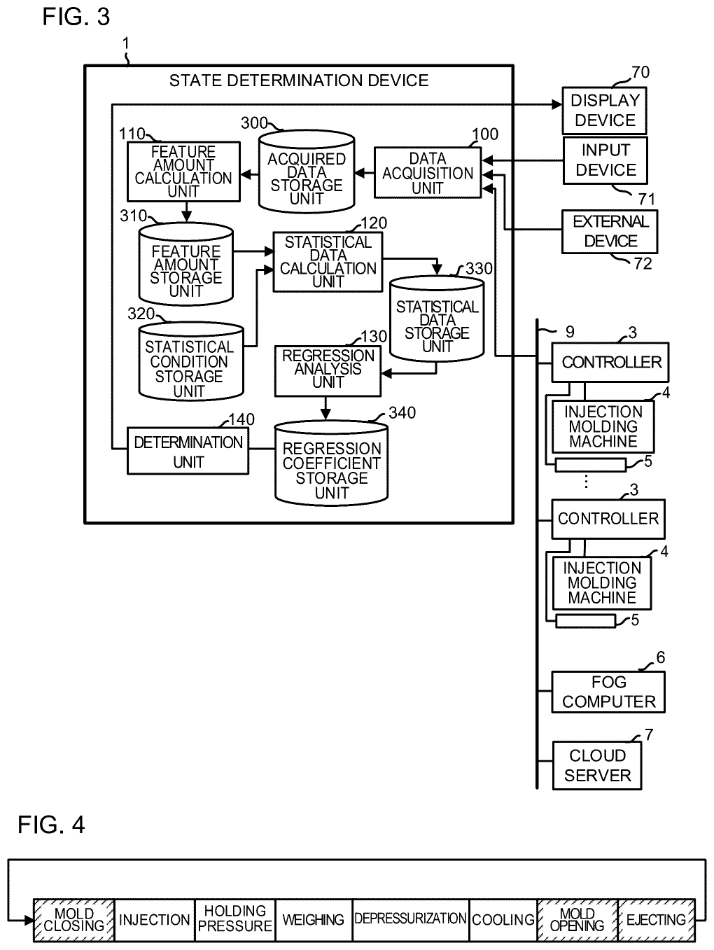

FIG. 3 is a schematic block diagram illustrating a function of the state determination device 1 according to a first embodiment of the present invention. Each function provided in the state determination device 1 according to the present embodiment is realized by the CPU 11 provided in the state determination device 1 illustrated in FIG. 1 executing a system program and controlling an operation of each unit of the state determination device 1.

The state determination device 1 of the present embodiment includes a data acquisition unit 100, a feature amount calculation unit 110, a statistical data calculation unit 120, a regression analysis unit 130, and a determination unit 140. In addition, in the RAM 13 or the nonvolatile memory 14 of the state determination device 1, an acquired data storage unit 300 as an area for storing data acquired by the data acquisition unit 100 from the controller 3, etc., a feature amount storage unit 310 as an area for storing a feature amount calculated by the feature amount calculation unit 110, a statistical condition storage unit 320 for pre-storing a statistical condition in calculation of statistical data by the statistical data calculation unit 120, a statistical data storage unit 330 as an area for storing statistical data calculated by the statistical data calculation unit 120, and a regression coefficient storage unit 340 as an area for storing a coefficient of a predetermined regression formula calculated by the regression analysis unit 130 are prepared in advance.

The data acquisition unit 100 is realized by the CPU 11 provided in the state determination device 1 illustrated in FIG. 1 executing a system program read from the ROM 12, and mainly performing arithmetic processing by the CPU 11 using the RAM 13 and the nonvolatile memory 14 and input control processing by the interface 15, 18, or 20. The data acquisition unit 100 acquires data related to the physical quantities such as the motor current, voltage, torque, position, speed, and acceleration of the driving unit, the pressure in the mold, the temperature of the injection cylinder 426, the flow rate of resin, the flow velocity of resin, and vibration and sound of the driving unit detected by the sensors 5 attached to the injection molding machine 4. The data related to the physical quantities acquired by the data acquisition unit 100 may be so-called time-series data indicating values of the physical quantities for each predetermined cycle. When acquiring the data related to the physical quantities, the data acquisition unit 100 also acquires the number of productions (the number of shots) when the physical quantities are detected. The number of productions (the number of shots) may be the number of productions (number of shots) after performing previous maintenance. The data acquisition unit 100 may acquire data directly from the controller 3 that controls the injection molding machine 4 via the network 9. The data acquisition unit 100 may acquire data acquired and stored by the external device 72, the fog computer 6, the cloud server 7, etc. The data acquisition unit 100 may acquire data related to physical quantities for each process included in one molding cycle by the injection molding machine 4. FIG. 4 is a diagram illustrating a molding cycle for manufacturing one molded product. In FIG. 4, a mold closing process, a mold opening process, and an ejecting process, which are processes in hatched frames, are performed by an operation of the mold clamping unit 401. In addition, an injection process, a holding pressure process, a weighing process, a depressurization process, and a cooling process, which are processes outlined in white, are performed by an operation of the injection unit 402. The data acquisition unit 100 acquires data related to physical quantities so that each of these processes can be distinguished. The data related to the physical quantities acquired by the data acquisition unit 100 is stored in the acquired data storage unit 300.

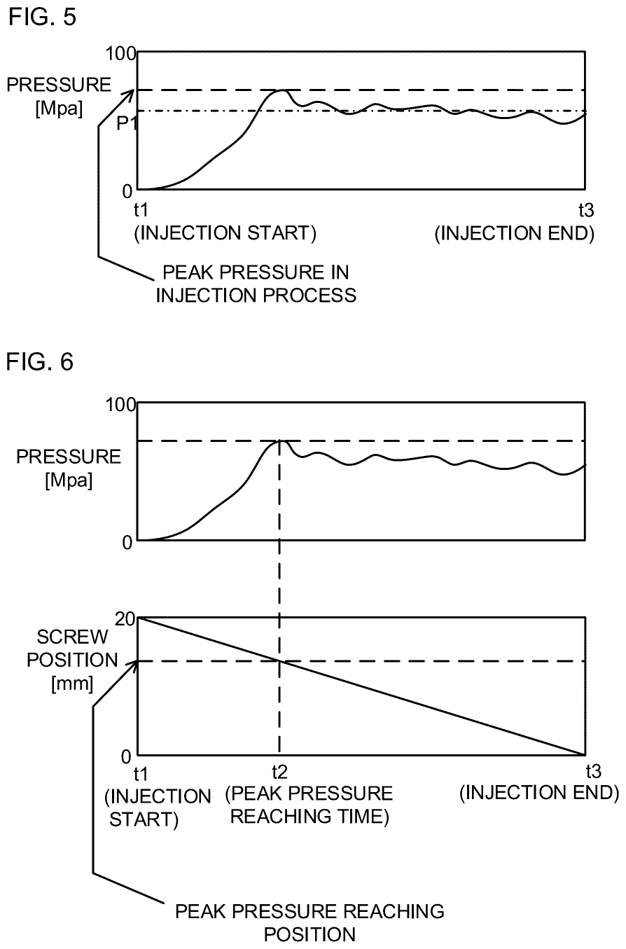

The feature amount calculation unit 110 is realized by the CPU 11 provided in the state determination device 1 illustrated in FIG. 1 executing a system program read from the ROM 12 and mainly performing arithmetic processing using the RAM 13 and the nonvolatile memory 14 by the CPU 11. The feature amount calculation unit 110 calculates a feature amount of data related to physical quantities (injection time, peak pressure, and a peak pressure reaching position in the injection process, a weighing pressure peak value and a weighing end position in the weighing process, a mold closing time in the mold closing process, a mold opening time in the mold opening process, etc.) for each process included in the molding cycle of the injection molding machine 4 based on data related to physical quantities indicating a state of the injection molding machine 4 acquired by the data acquisition unit 100. The feature amount calculated by the feature amount calculation unit 110 indicates a feature of a state of each process of the injection molding machine 4. FIG. 5 is a graph indicating a change in pressure during the injection process. In FIG. 5, t1 indicates a start time of the injection process, and t3 indicates an end time of the injection process. The pressure is controlled by the controller 3 that controls the injection molding machine 4 so that the pressure starts to rise as resin in the injection cylinder is injected into the mold, and then reaches a predetermined target pressure P1. The predetermined target pressure P1 is manually set in advance by the operator visually confirming an operation screen displayed on the display device 70 and operating the input device 71 as a command based on an operation of the operator. As illustrated in FIG. 5, the feature amount calculation unit 110 calculates a peak value of time-series data indicating the pressure acquired in the injection process, and uses the peak value as a feature amount of the peak pressure in the injection process. FIG. 6 is a graph illustrating a change in the pressure and a change in the screw position during the injection process. As illustrated in FIG. 6, the feature amount calculation unit 110 calculates the peak pressure in the injection process, then calculates a screw position at a peak pressure reaching time t2 at which the peak pressure is reached, and uses this screw position as a feature amount of a peak pressure reaching position in the injection process. In this way, the feature amount calculated by the feature amount calculation unit 110 may be calculated based on data related to a predetermined physical quantity in a predetermined process, or may be calculated from data related to a plurality of physical quantities in a predetermined process. The feature amount calculated by the feature amount calculation unit 110 is stored in the feature amount storage unit 310 in association with the number of productions (number of shots) by the injection molding machine 4.

The statistical data calculation unit 120 is realized by the CPU 11 provided in the state determination device 1 illustrated in FIG. 1 executing a system program read from the ROM 12 and mainly performing arithmetic processing by the CPU 11 using the RAM 13 and the nonvolatile memory 14. The statistical data calculation unit 120 calculates statistical data, which is a statistic of the feature amount, based on a feature amount indicating a feature of a state of the injection molding machine 4 calculated by the feature amount calculation unit 110. The statistical data calculation unit 120 refers to a statistical condition stored in the statistical condition storage unit 320 when calculating the statistical data.

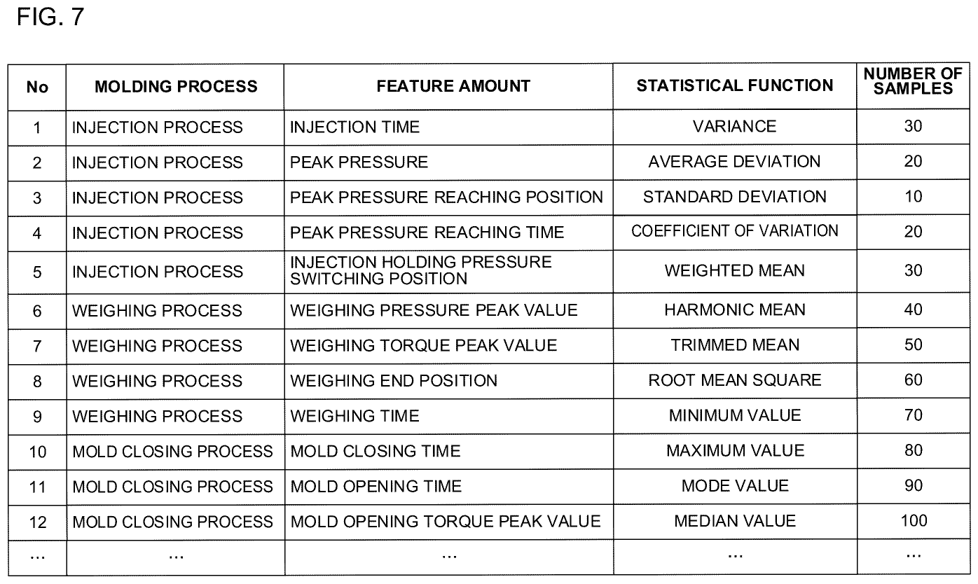

The statistical condition stored in the statistical condition storage unit 320 defines a condition for calculating a statistic (for example, an average value, a variance, etc.) from a feature amount. FIG. 7 illustrates an example of the statistical condition stored in the statistical condition storage unit 320. As illustrated in FIG. 7, the statistical condition associates a feature amount with a statistical function for calculating a statistic from the feature amount. As illustrated in FIG. 7, the statistical condition may be defined for each process included in a molding cycle. Further, as illustrated in FIG. 7, the statistical condition may include the number of samples of the feature amount when calculating the statistic. For example, the statistical function included in statistical condition may be a weighted mean, an arithmetic mean, a weighted harmonic mean, a harmonic mean, a trimmed mean, a logarithmic mean, a root mean square, a minimum value, a maximum value, a median value, a weighted median value, a mode value, etc. A test operation of the injection molding machine 4 may be performed in advance, a correlation between a molding state of a molded product by the injection molding machine 4 and each statistic calculated from the feature amount may be analyzed, and an appropriate statistical function may be selected as this statistical function based on an analysis result thereof. For example, when a maximum value of a predetermined feature amount changes as the molding state of the molded product by the injection molding machine 4 changes, the maximum value may be selected as a statistical function for calculating a statistic of the feature amount. In addition, when an outlier that deviates significantly from an average value of a feature amount is included in a plurality of feature amounts, a weighted median value, a mode value, etc. less susceptible to an influence of the outlier may be selected as a statistical function. In addition, for example, when a value of a predetermined feature amount varies as the molding state of the molded product by the injection molding machine 4 changes, a standard deviation may be selected as a statistical function for calculating a statistic of the feature amount. Note that the statistical function indicating variation of the value of the feature amount is not limited to the standard deviation, and may be a variance, a standard deviation, an average deviation, a coefficient of variation, etc. As such, it is desirable to select a statistical function useful for determining a change in the state of the injection molding machine 4 as the statistical condition related to the predetermined feature amount.

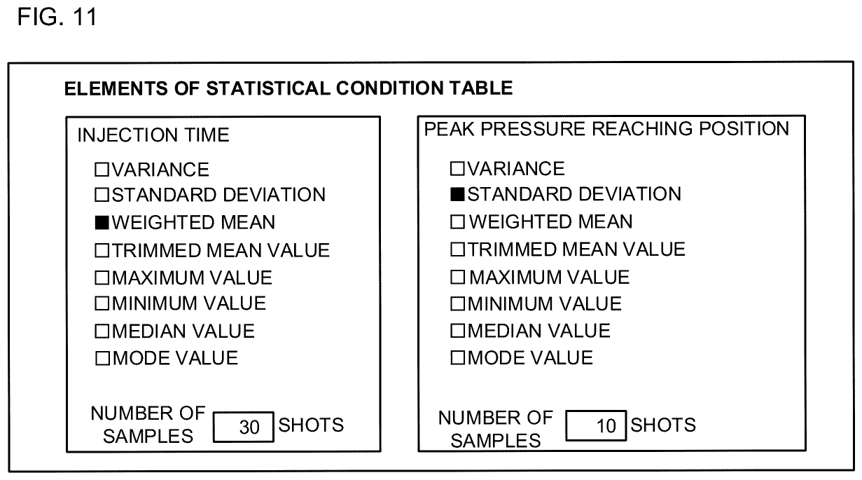

As illustrated in FIG. 11, the operator may manually set and update the statistical condition by operating the input device 71 from the operation screen displayed on the display device 70. FIG. 11 illustrates a display example when the operator selects a weighted average as a statistical function for calculating a statistic from the injection time of the feature amount, and selects a standard deviation as a statistical function for calculating a statistic from the peak pressure reaching position of the feature amount. In addition, the figure illustrates that the number of samples used by the statistical function to calculate the statistic is 30 shots in the case of the injection time of the feature amount and is 10 shots in the case of the peak pressure reaching position of the feature amount. As a method of determining the number of samples, a small value may be selected as the number of samples when the value of the feature amount changes with a small number of shots as in the case of the injection time or the peak pressure reaching position, and a large value such as 90 shots may be selected as the number of samples when a value of a feature amount is stable for each shot and changes little as in the case of the mold opening time, or when the feature amount changes slowly over a large number of shots as in the case of the temperature of the injection cylinder 426. In this way, a different number of shots may be appropriately selected as the number of samples depending on how the feature amount changes for each shot.

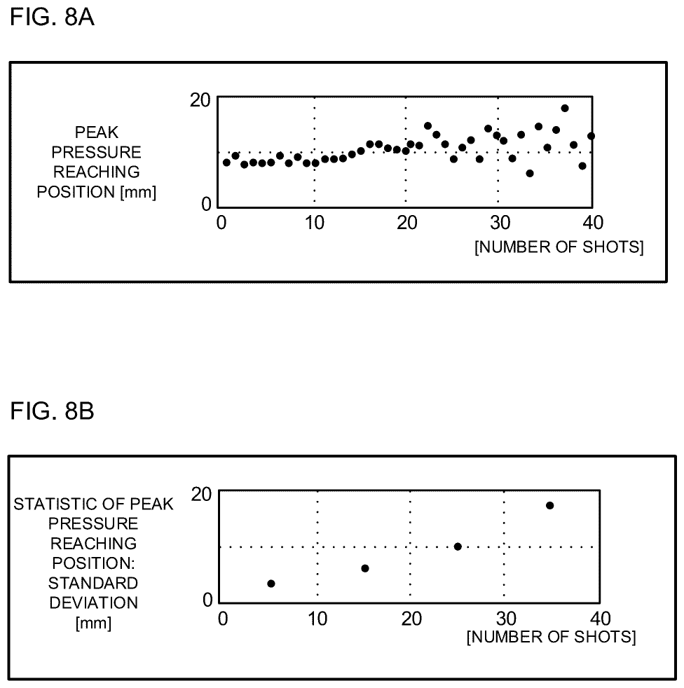

The statistical data calculation unit 120 refers to the statistical condition stored in the statistical condition storage unit 320 to calculate statistical data from a feature amount stored in the feature amount storage unit 310 at a predetermined timing. For example, the statistical data calculation unit 120 may calculate statistical data for each predetermined molding cycle (every shot, every ten shots, every number of samples set in the statistical condition, etc.). FIGS. 8A and 8B illustrate examples of statistical data of the peak pressure reaching position. FIG. 8A is a graph plotting the feature amount for each shot, and FIG. 8B is a graph plotting statistical data calculated from the feature amount, respectively. As illustrated in FIG. 7, the statistical condition (statistical condition No. 3) for calculating a statistic of the peak pressure reaching position defines 10 shots as the number of samples and a standard deviation as the statistical function. At this time, the statistical data calculation unit 120 calculates a standard deviation of each feature amount of the peak pressure reaching position calculated for each shot separately every 10 shots, and uses a result thereof as the statistical data of the peak pressure reaching position. The statistical data calculation unit 120 stores the statistical data calculated in this way in the statistical data storage unit 330 in association with the number of productions (number of shots) depending on the injection molding machine 4. Note that, when determining the statistical function defined in the statistical condition, the operator may visually check a distribution state of the feature amount plotted in FIG. 8A and select the statistical function.

The regression analysis unit 130 is realized by the CPU 11 provided in the state determination device 1 illustrated in FIG. 1 executing a system program read from the ROM 12 and mainly performing arithmetic processing by the CPU 11 using the RAM 13 and the nonvolatile memory 14. The regression analysis unit 130 performs regression analysis on statistical data related to each physical quantity with reference to statistical data stored in the statistical data storage unit 330, and calculates a coefficient of a predetermined regression formula. The regression analysis unit 130 stores the calculated coefficient of the regression formula in the regression coefficient storage unit 340.

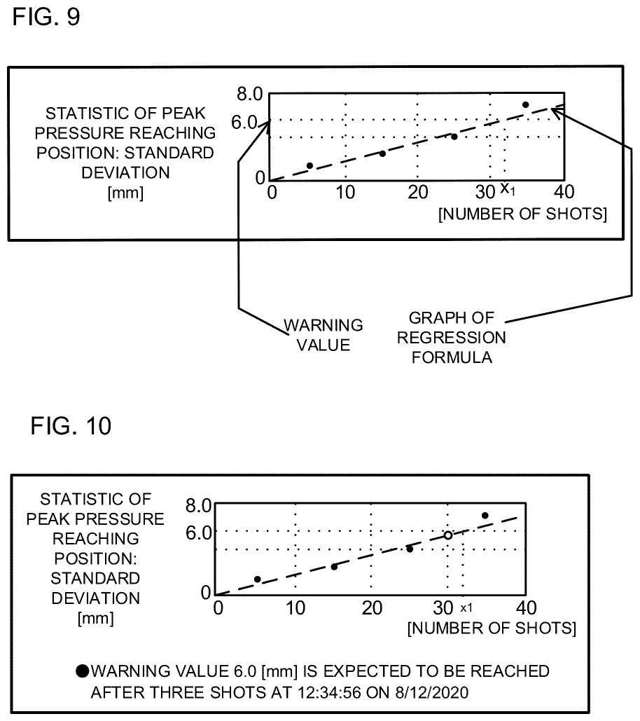

FIG. 9 illustrates an example of a graph of a regression formula obtained by performing regression analysis on the statistical data of the peak pressure reaching position illustrated in FIG. 8B. A straight line indicated by a dotted line in FIG. 9 is obtained by the regression analysis unit 130 performing simple regression analysis using a linear regression formula y=ax+b as a predetermined regression formula. At this time, for example, the regression analysis unit 130 sets a target variable y as a statistic (standard deviation) of the peak pressure reaching position, sets an explanatory variable x as the number of productions (number of shots), and calculates coefficients a and b that minimize an error (estimation error) between a value estimated from the explanatory variable x and the target variable y using a least squares method. The calculated coefficients a and b are stored in the regression coefficient storage unit 340. As the predetermined regression formula, in addition to the linear regression formula described above, it is possible to use a root regression formula, a natural logarithmic regression formula, a fractional regression formula, a power regression formula, an exponential regression formula, a modified exponential regression formula, a logistic regression formula, etc. depending on the tendency of change in the statistic at any time. When selecting the predetermined regression formula, the operator may visually check a distribution state of the statistic plotted in FIG. 9 to adopt a regression formula suitable for the tendency of change in the statistic (a linear regression formula, which is a linear expression, in the case of a linear change, an exponential regression formula, which is an nth-order expression, in the case of a curvilinear change, or other regression formulae).

The determination unit 140 is realized by the CPU 11 provided in the state determination device 1 illustrated in FIG. 1 executing a system program read from the ROM 12 and mainly performing arithmetic processing by the CPU 11 using the RAM 13 and the nonvolatile memory 14. The determination unit 140 determines a timing at which each statistic reaches a predetermined warning value based on a regression formula, a coefficient of which is determined by the regression analysis unit 130. The number of productions (number of shots), which is the timing at which the warning value is reached, is inversely estimated by substituting the warning value into the target variable y of x=(y−b)/a obtained by solving the linear regression equation with respect to the explanatory variable x. As for the warning value, a test operation is performed in advance, and a statistic value at which the injection molding machine 4 cannot perform a normal molding operation may be obtained. In the example of FIG. 9, the warning value of the standard deviation of the peak pressure reaching position is set to 6 mm, and the determination unit 140 determines the number of productions (number of shots) x₁, which is a timing at which a value calculated from the regression formula reaches the warning value 6.0 mm, to be a timing at which a warning is issued. Then, the determination unit 140 outputs a determination result thereof. The determination unit 140 may display and output the determination result on and to the display device 70. Further, the determination unit 140 may transmit and output the determination result to the controller 3 of the injection molding machine 4 or a host device such as the fog computer 6 or the cloud server 7 via the network 9.

A timing of issuing a warning determined by the determination unit 140 may be the number of productions (the number of shots, x₁ in the example of FIG. 9) depending on the injection molding machine 4 as described above. In addition, in view of the current number of productions (number of shots) of the injection molding machine 4, the remaining number of productions (the number of shots, in the example of FIG. 9, x₁−30 when 30 shots are currently being made) until the warning is reached may be displayed on and output to the display device 70 for each molding cycle. In addition, as another example of display output, the number of productions (number of shots) may be converted into the date and time or the remaining time and displayed on and output to the display device 70 based on a time required for one shot, a pace, a cycle time, etc. of a current injection operation. FIG. 10 illustrates a warning display including the number of remaining productions (number of shots) until the warning value is reached and the date and time when the warning value is reached, as an example of displaying and outputting a determination result by the determination unit 140.

In addition, the determination unit 140 calculates a divergence degree indicating how much each most recent statistic deviates from a regression formula based on the regression formula, a coefficient of which is determined by the regression analysis unit 130. Then, when the divergence degree exceeds a predetermined threshold value, information thereof is output as a warning. At this time, a plurality of predetermined threshold values may be provided.

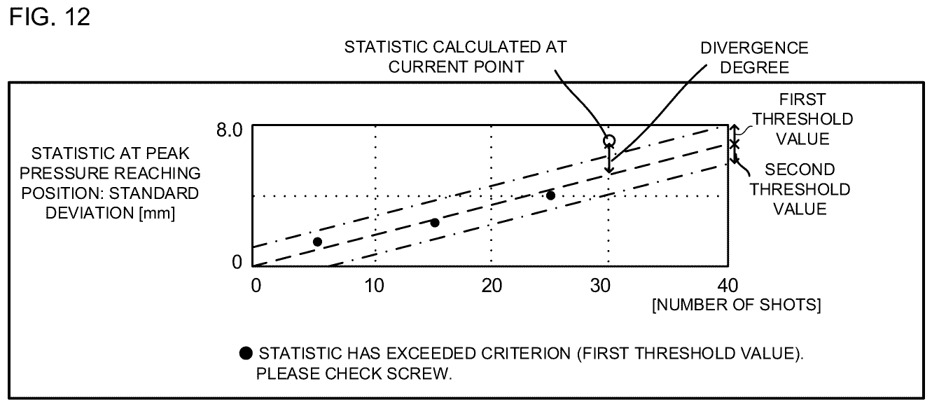

When the plurality of predetermined threshold values is provided, separate threshold values may be provided in each of the upward direction and a downward direction of the regression formula. FIG. 12 is an operation screen displayed on the display device 70, and is a diagram illustrating an example in which threshold values are provided above and below the regression formula. In FIG. 12, a dotted line indicates a graph of a linear regression formula. In addition, two dashed lines illustrate positions indicating positions vertically separated from the graph of the linear regression formula by first and second threshold values, respectively. When the threshold values are set in this way, upon calculating a statistic based on data related to a physical quantity acquired from the injection molding machine 4, the determination unit 140 calculates, as a divergence degree, a difference between the statistic and a value (estimated statistic) obtained by substituting the current number of shots into a regression formula related to the previously calculated statistic. Then, when the divergence degree exceeds either the first threshold value (divergence in the upward direction) or the second threshold value (divergence in the downward direction), information thereof is output as a warning. As an example of the warning, when the divergence degree exceeds the first threshold value (divergence in the upward direction) in the upward direction, a message “Statistic has exceeded criterion (first threshold value). Please check screw” illustrated in FIG. 12 is displayed on the operation screen, and when the divergence degree exceeds the second threshold value (divergence in the downward direction) in the downward direction, a message different from that in the case of the first threshold value may be displayed on the operation screen, or the operation of the injection molding machine may be suspended. In this way, different warnings can be output between the case where the first threshold value is exceeded and the case where the second threshold value is exceeded.

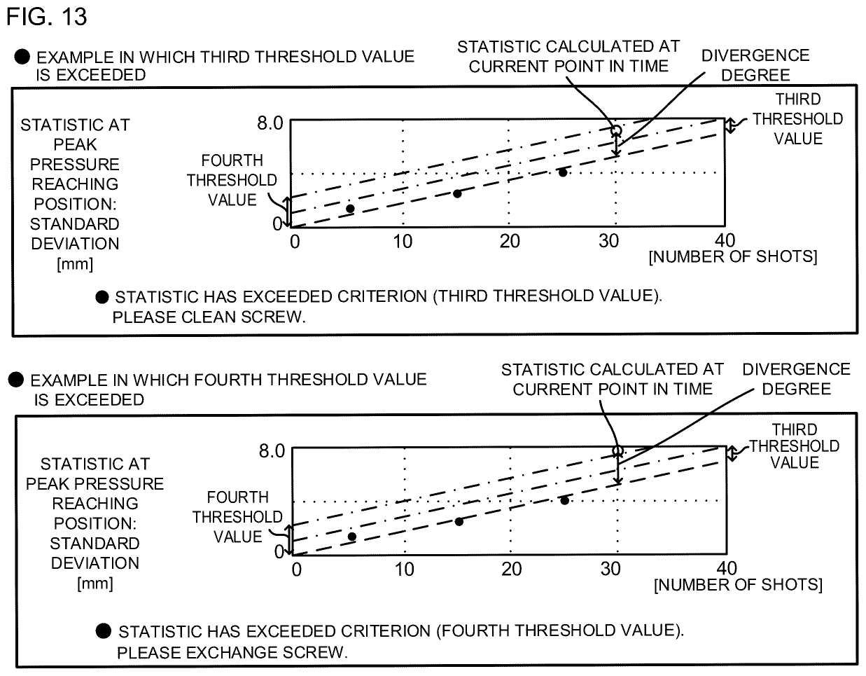

When the plurality of predetermined threshold values is provided, the threshold values may be provided stepwise in the same direction of the regression formula. FIG. 13 is an operation screen displayed on the display device 70, and is a diagram illustrating an example in which the plurality of threshold values is provided stepwise in the upward direction of the regression formula. In FIG. 13, a dotted line indicates a graph of a linear regression formula. In addition, two dashed lines illustrate positions indicating positions separated from the graph of the linear regression formula by third and fourth threshold values, respectively, in the upward direction. When the threshold values are set in this way, upon calculating a statistic based on data related to a physical quantity acquired from the injection molding machine 4, the determination unit 140 calculates, as a divergence degree, a difference between the statistic and a value (estimated statistic) obtained by substituting the current number of shots into a regression formula related to the previously calculated statistic. Then, different warnings are output such that, when the divergence degree exceeds the third threshold value (divergence of a first stage in the upward direction) and is less than or equal to the fourth threshold value (divergence of a second stage in the upward direction), the operation of the injection molding machine is decelerated, and when the divergence degree exceeds the fourth threshold value (divergence of the second stage in the upward direction), the operation of the injection molding machine is suspended. When a plurality of threshold values is present for the same direction in the regression formula, a warning can be output to impose greater constraint on the injection molding machine for a larger threshold value.

Note that, when a plurality of threshold values is provided stepwise in this way, three or more stages may be provided, and each divergence degree may be calculated and determined, which may be combined with the case where threshold values are provided in the upward direction and the downward direction, respectively.

The statistic estimated based on the regression formula functions as a criterion for determining normality or abnormality of a statistic calculated from data related to a physical quantity acquired from the injection molding machine 4 in a current operating state. After maintenance is performed, the injection molding machine 4 undergoes abrasion of the screw or wear of the belt as the molding operation is repeated. Therefore, the statistic calculated based on the physical quantity acquired from the injection molding machine 4 gradually changes as the molding operation is performed immediately after the maintenance even when the molding operation is normally performed. In the invention, this change is obtained as a regression formula, and used as a criterion for detecting an accidentally occurring abnormality. Conventionally, normality or abnormality has been determined using a divergence degree from a fixed reference value for a statistic. However, in the invention, the tendency of change in the statistic is obtained as a regression formula, and it is determined whether the molding operation is normal or abnormal based on the divergence degree from this regression formula. A statistic obtained by a molding operation repeatedly performed in the past is reflected in the regression formula. That is, since a process of progress of a state such as abrasion of the screw or wear of the belt occurring due to the repeatedly performed molding operation is reflected in the regression formula, it is possible to perform determination considering transition of the molding state by actual molding. In this way, it is possible to accurately determine normality or abnormality based on a current state of the injection molding machine 4.

The state determination device 1 according to the present embodiment having the above configuration can detect the number of productions or a date and time at which production abnormality is predicted to occur in the future based on time-series data obtained by actual molding. In addition, when a statistic calculated based on an actually measured value deviates from a regression formula, a safe state is achieved in such a way that the operator is notified that an accidental abnormality has occurred, or the injection molding machine is suspended. As a result, preventive maintenance can be carried out in a planned manner, which reduces the frequency of conventional periodic inspection work, reduces the burden on the operator, and improves the work efficiency and operating rate. In this way, the operator can take measures to continue production (for example, replenishing the movable portion with grease, adjusting an operating condition, etc.) before an abnormality occurs, minimizing downtime, and improve the operating rate. In addition, since production of a defective product can be prevented, the cost can be reduced. The determination is not determination of the presence or absence of an abnormality depending on experience and intuition of the operator, and estimation is made based on numerical information obtained by actual molding, which realizes reproducible and stable determination.

Even though one embodiment of the present invention has been described above, the invention is not limited to the above-described examples of the embodiment, and can be implemented in various modes by adding appropriate modifications.

For example, the determination unit 140 in the above-described embodiment not only outputs a determination result, but also may output a signal, etc. for suspending or decelerating the operation of the injection molding machine 4 or limiting driving torque of a prime mover driving the injection molding machine 4 when the determined number of productions or date and time is reached, and a divergence degree exceeds a predetermined threshold value. By adopting such a configuration, it is possible to automatically suspend the operation of the injection molding machine 4 before defective molding increases, or to put the injection molding machine 4 in a safe standby state to prevent damage to the injection molding machine 4.

In addition, when a plurality of injection molding machines 4 is interconnected via the network 9, data may be acquired from the plurality of injection molding machines, and a molding state of each injection molding machine may be determined by one state determination device 1, or the state determination device 1 may be disposed on each of controllers provided in the plurality of injection molding machines, and a molding state of each injection molding machine may be determined by each state determination device provided in the injection molding machine.

1. A state determination device for determining a molding state in an injection molding machine, the state determination device comprising:
a data acquisition unit configured to acquire the number of productions and data related to a predetermined physical quantity as data indicating a state related to the injection molding machine;
a feature amount calculation unit configured to calculate a feature amount indicating a feature of a state of the injection molding machine based on the data related to the physical quantity;
a feature amount storage unit configured to associate and store the feature amount and the number of productions;
a statistical condition storage unit configured to store a statistical condition including at least a statistical function for calculating a predetermined statistic from a predetermined feature amount;
a statistical data calculation unit configured to calculate a statistic as statistical data with reference to a statistical condition stored in the statistical condition storage unit based on the feature amount stored in the feature amount storage unit;
a statistical data storage unit configured to associate and store the statistical data and the number of productions;
a regression analysis unit configured to perform regression analysis using a predetermined regression formula based on statistical data and the number of productions stored in the statistical data storage unit, and calculate a coefficient of the predetermined regression formula; and
a determination unit configured to calculate a divergence degree indicating a degree of divergence of a most recent statistic calculated by the statistical data calculation unit from the predetermined regression formula, and determine whether or not the divergence degree is greater than at least one predetermined threshold value.

2. The state determination device according to claim 1, wherein the statistical function is any one of a variance, a standard deviation, an average deviation, a coefficient of variation, a weighted mean, a weighted harmonic mean, a trimmed mean, a root mean square, a minimum value, a maximum value, a mode value, and a weighted median value.

3. The state determination device according to claim 1, wherein the predetermined regression formula is any one of a linear regression formula, a root regression formula, a natural logarithmic regression formula, and a logistic regression formula.

4. The state determination device according to claim 1, wherein:
a first threshold value for determining divergence of the regression formula in an upward direction and a second threshold value for determining divergence of the regression formula in a downward direction are set as the threshold value; and
when a most recent statistic diverges from the regression formula in the upward direction by more than the first threshold value, or diverges from the regression formula in the downward direction by more than the second threshold value, the determination unit outputs information thereof as a determination result.

5. The state determination device according to claim 1, wherein:
a third threshold value and a fourth threshold value greater than the third threshold value are set as the threshold value; and
the determination unit outputs different determination results between a case where the divergence degree is greater than the third threshold value and less than or equal to the fourth threshold value and a case where the divergence degree is greater than the fourth threshold value.

6. The state determination device according to claim 1, wherein the data acquisition unit acquires data from a plurality of injection molding machines connected via a wired or wireless network.

7. The state determination device according to claim 1, wherein the state determination device is mounted on a host device connected to the injection molding machine via a wired or wireless network.

8. The state determination device according to claim 1, wherein a result of determination by the determination unit is displayed on and output to a display device.

9. The state determination device according to claim 1, wherein, when the determination unit determines that the divergence degree is greater than the predetermined threshold value, at least one of signals for suspending or decelerating an operation of the injection molding machine or limiting driving torque of a prime mover driving the injection molding machine is output.

10. A state determination method of determining a molding state in an injection molding machine, the state determination method executing:
a step of acquiring the number of products and data related to a predetermined physical quantity as data indicating a state related to the injection molding machine;
a step of calculating a feature amount indicating a feature of a state of the injection molding machine based on the data related to the physical quantity;
a step of calculating a statistic as statistical data according to a statistical condition including at least a statistical function for calculating a predetermined statistic from a predetermined feature amount based on the feature amount;
a step of performing regression analysis using a predetermined regression formula based on the statistical data and the number of productions, and calculating a coefficient of the predetermined regression formula; and
a step of calculating a divergence degree indicating a degree of divergence of a most recently calculated statistic from the predetermined regression formula, and determining whether or not the divergence degree is greater than at least one predetermined threshold value.
